(19) United States
(12) Patent Application Publication
(10) Pub. No.: US 2026/0246523 A1
(43) Pub. Date: Aug. 20, 2026

(54) CHANNEL STATE INFORMATION REPORTING

(71) Applicant: ZTE CORPORATION, Shenzhen (CN)

(72) Inventors: Shujuan ZHANG, Shenzhen (CN); Yijian CHEN, Shenzhen (CN); Mengnan JIAN, Shenzhen (CN); Hongkang YU, Shenzhen (CN)

(21) Appl. No.: 19/161,585

(22) PCT Filed: Mar. 3, 2023
(86) PCT No.: PCT/CN2023/079589

§ 371 Date: Sep. 2, 2025

(51) Int. Cl. H04B 7/06; H04W 72/0453

(52) U.S. Cl. CPC H04B 7/0639; H04B 7/0626; H04B 7/0632; H04W 72/0453

(57) ABSTRACT

Systems, methods, and apparatus for wireless communication are described. A wireless communication method may include determining, by a wireless communication node, a precoding matrix for each frequency domain location of one or more frequency domain locations according to a first type of vector including a first plurality of elements, where a phase of each element of the first plurality of elements is based on a product of a first parameter and a second parameter, where the first parameter is based on an index of a first type of frequency domain unit corresponding to the each frequency domain location of the one or more frequency domain locations, and where the second parameter is based on an index of the each element of the first plurality of elements. The method may further include transmitting, by the wireless communication node, information based on the precoding matrix.

### CROSS-REFERENCE TO RELATED APPLICATION

This application is a national stage filing under 35 U.S.C. § 371 of international application number PCT/CN2023/079589, filed Mar. 3, 2023, the contents of which are incorporated herein by reference in its entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability, and other emerging business needs.

### SUMMARY

Techniques are disclosed for reporting channel state information (CSI) by determining a precoding matrix.

A first example wireless communication method may include determining, by a wireless communication node, a precoding matrix for each frequency domain location of one or more frequency domain locations according to a first type of vector including a first plurality of elements, where a phase of each element of the first plurality of elements is based on a product of a first parameter and a second parameter, where the first parameter is based on an index of a first type of frequency domain unit corresponding to the each frequency domain location of the one or more frequency domain locations, and where the second parameter is based on an index of the each element of the first plurality of elements. The method may further include transmitting, by the wireless communication node, information based on the precoding matrix.

A second example wireless communication method may include determining, by a network wireless communication node, a precoding matrix for each frequency domain location of one or more frequency domain locations according to a first type of vector including a first plurality of elements, where a phase of each element of the first plurality of elements is based on a product of a first parameter and a second parameter, where the first parameter is based on an index of a first type of frequency domain unit corresponding to the each frequency domain location of the one or more frequency domain locations, and where the second parameter is based on an index of the each element of the first plurality of elements. The method may further include transmitting, by the network wireless communication node, a signal based on the precoding matrix.

A third example wireless communication method is based on the first and second example wireless communication methods, where the precoding matrix for the each frequency domain location is further according to a second type of vector including a second plurality of elements, where a phase of each element of the second plurality of elements is based on a third parameter, and where the third parameter is based on an index of the each element of the second plurality of elements.

A fourth example wireless communication method is based on the third example wireless communication method, where the precoding matrix for the each frequency domain location is further according to one or more third type of vectors, where each third type of vector of the one or more third type of vectors may include a third plurality of elements, and where the each third type of vector is based on the first type of vector and the second type of vector. Each element of the third plurality of elements of the each third type of vector is based on a product of an index of an element of the first plurality of elements of the first type of vector and an index of an element of the second plurality of elements of the second type of vector. A number of the third plurality of elements is based on a product of a number of the first plurality of elements and a number of the second plurality of elements.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an exemplary beam alignment.

FIG. 2 illustrates an exemplary frequency resource unit alignment.

FIG. 3 is an exemplary flowchart for determining a precoding matrix based on a first type of vector and transmitting information.

FIG. 4 is an exemplary flowchart for determining a precoding matrix based on a first type of vector and transmitting a signal.

FIG. 5 is an exemplary flowchart for determining a precoding matrix based on a second type of vector.

FIG. 6 is an exemplary flowchart for determining a precoding matrix based on a third type of vector.

FIG. 7 illustrates an exemplary block diagram of a hardware platform that may be a part of a network device or a communication device.

FIG. 8 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

In the case where different frequency domain locations correspond to different precoding matrices while the overhead of reporting the precoding matrices by the user equipment (or informed by the base station) does not increase, methods to determine more accurate precoding matrices are needed. This patent document presents these methods in Embodiments 1-4 below.

### I. Embodiment 1

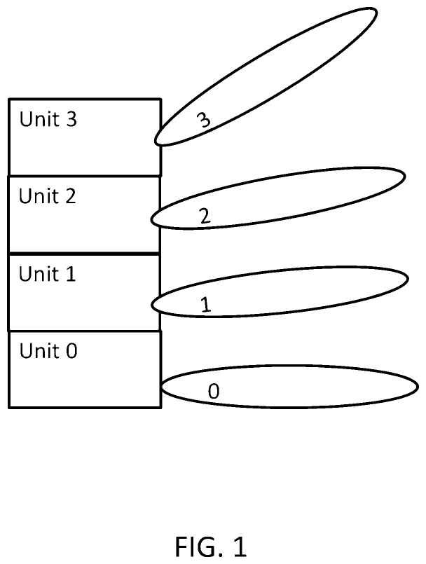

If the bandwidth is larger than a threshold, then different frequency resource units may correspond to different beams. Then to align these different beams for a same UE location, the precoding should be different for different frequency resource units as shown in FIG. 1. Different frequency resource units corresponding to different beams may be due to the ratio between the wavelength and the distance is different for different frequency resource units. It may also be due to the large number of antennas and the large frequency bandwidth.

For example, the precoding matrix for one first type of frequency domain unit is based on a first type of vector having N₁ elements, where the phase of each element of the first type of vector is based on a product of a first parameter and a second parameter. The first parameter at least depends on an index of the first type of frequency domain unit. The second parameter at least depends on an index of the element of the first type of vector. Because the product of the element with index 0 is always 0, we can view the element with index 0 of the first type of vector also follows above feature, which is the phase of the element with index 0 is based on the product of the first parameter and the second parameter. Of course, we can name that each element except the element with index 0 of the first type of vector is based on the product. N₁ is an integer larger than 0.

In some implementation, the first parameter also depends on a frequency of a carrier.

In some implementation, the frequency of the carrier is determined by a received signaling. For example, the received signaling informs the frequency domain information about the carrier. The frequency of the carrier belongs to one first type of frequency domain unit whose index is 0.

In some implementation, the first parameter depends on a ratio between the size of the frequency domain unit and the frequency of the carrier.

In a word, the first parameter is determined by at least one of the index of the first type of frequency domain unit, the size of the first type of frequency domain unit, the frequency of the carrier, the ratio between the size of the frequency domain unit and the frequency of the carrier, a parameter indicated by a gNB for the CSI reporting. For example, the parameter indicated by the gNB includes at least one of the frequency of the carrier and the ratio between the size of the first type of frequency domain unit and the frequency of the carrier.

In some implementation, the second parameter depends on a fourth parameter. The fourth parameter applies for all elements of the first type of vector. That is all elements of the first type of vector correspond to a same value of the fourth parameter. Alternatively, we can say that the fourth parameter applies for all elements of the first type of vector expect for the element with index 0 of the first type of vector.

In some implementation, the fourth parameter is based on information reported by the UE in CSI (channel state information) including information about the precoding matrix. For example, the fourth parameter reported by the UE corresponds to a parameter of a spatial domain vector. The spatial domain vector has the same number of elements as the first type of vector, such as the spatial domain vector includes N₁ elements. The index of the spatial domain vector applies to all elements of the spatial domain vector. The index of the spatial domain vector is an index of the spatial domain vector among multiple spatial domain vectors.

In some implementation, the second parameter depends on N₁.

In some implementation, the second parameter depends on O₁. O₁ is a positive integer. In some implementation, O₁ is determined by a received signaling from gNB. In some implementation, O₁ is named as an oversampling factor.

In some implementation, the second parameter at least depends on an index of the element of the first type of vector. In some implementations, the second parameter at least depends on y power of the index of the element of the first type of vector, where y is a positive integer. For example, y∈{1, 2, . . . }.

In a word, the second parameter is determined by at least one of: an index of the element of the first type of vector, the fourth parameter applied to all elements of the first type of vector, N₁O₁, or the power of the index of the element of the first type of vector.

For example, an element with index n, n∈{0, 1, . . . , N₁−1} of the first type of vector for a first type of frequency domain unit k∈{0, 1, . . . F−1} has following format:

$${w}_{n , 1} = exp ( j 2 π ab )$$

$$b = - nc + {n}^{2} d$$

where F is the number of the first type of frequency domain units. The a is the first parameter which depends on k. The b is the second parameter which depends on n.

In some implementation, the index of the first type of frequency domain unit k∈{0, 1, . . . F−1} can be replaced with k∈{−x₁, −x₁+1, . . . , 0, 1, . . . x₂}.

In some implementation, F=x₂+x₁+1. The k=0 corresponds to the carrier. We also can name the carrier corresponds to a frequency location with k=0.

In some implementation,

$${x}_{1} = ⌊ \frac{F - 1}{2} ⌋ or {x}_{1} = ⌈ \frac{F - 1}{2} ⌉$$

In some implementation,

$${x}_{2} = ⌊ \frac{F - 1}{2} ⌋ or {x}_{2} = ⌈ \frac{F - 1}{2} ⌉$$

In some implementation, at least one of the x₁ and x₂ are determined by a received signaling from gNB.

In some implementation,

$$a = \frac{k Δ f}{{f}_{0}} ,$$

where Δf is the size of one first type of frequency domain unit. f₀ is the frequency of the carrier. For example, f₀=2 GHz.

In some implementation,

$$a = \frac{k Δ f}{{f}_{0}} + 1$$

In some implementation, a=kr or a=kr+1, where r is a real number determined by at least one of a rule or a received signaling from gNB.

In some implementation, r is the ratio between the size of one first type of frequency domain unit Δf and the frequency of the carrier f₀. For example,

$$r = \frac{Δ f}{{f}_{0}} .$$

Strictly speaking, the a for a first type of frequency domain unit k should be named as aₖ or a(k). For simplicity, we ignore k.

In some implementation, b has at least one of following format:

$$b = nc$$

$$b = nc - {n}^{2} d$$

$$b = - nc + {n}^{2} d$$

$$b = nc + {n}^{2} d$$

$$b = - nc - {n}^{2} d$$

where 0≤c<1. In some implementation, the fourth parameter includes the c. For example, the fourth parameter includes

$$c = \frac{{m}_{1} {O}_{1} + {q}_{1}}{{N}_{1} {O}_{1}} ,$$

where the fourth parameter is based on information reported by the UE. The information reported by the UE includes m₁, q₁. m₁∈{0, 1, . . . N₁−1} and q₁∈{0, 1, . . . O₁−1}. d>0.

In some implementation, the d is determined by at least one of N₁, a received signaling from gNB, the fourth parameter based on information reported by the UE. For example, the fourth parameter includes d which is reported by the UE. The UE can report d directly. Alternatively, the UE reports information related to d. The d is determined by the reported information and at least one of information informed by the gNB or some fixed value. In a word, the UE reports information about at least one of c, d, m₁, q₁.

In some implementation, the first type of vector for a first type of frequency domain unit k has the following format:

$${W}_{1} = [ \begin{matrix}{w}_{0 , 1} \\ {w}_{1 , 1} \\ ⋮ \\ {w}_{{N}_{1} - 1 , 1}\end{matrix} ]$$

In some implementation, the precoding matrix is the first type of vector. That is:

$${W}_{precodingmatrix} = {W}_{1}$$

Strictly speaking, the b for w_{n,1} should be named as bₙ or b(n). For simplicity, we ignore n.

In some implementation, the precoding matrix is also based on a second type of vector including N₂ elements. An element with index l of the N₂ elements is determined by a third parameter depending on l where l∈{0, 1, . . . N₂−1} or l∈{1, . . . N₂−1}. For example, the element with index l of N₂ elements has the following format:

$${w}_{l , 2} = exp ( j 2 π e )$$

The third parameter e has similar feature of the second parameter b described above except that N₁, O₁, m₁, q₁c, d n, D, the fourth parameter and b are replaced with N₂, O₂, m₂, q₂, c₂, d₂, l, D₂, the fifth parameter and e respectively. For example, the third parameter has one of the following formats:

$$e = l {c}_{2}$$

$$e = l {c}_{2} - {l}^{2} {d}_{2}$$

$$e = - l {c}_{2} + {l}^{2} {d}_{2}$$

$$e = l {c}_{2} + {l}^{2} {d}_{2}$$

$$e = - l {c}_{2} - {l}^{2} {d}_{2}$$

In some implementation, the phase of an element with index l of N₂ elements of the second type of vector based on the first parameter and the third parameter. For example,

$${w}_{l , 2} = exp ( j 2 π ae )$$

Strictly speaking, the e for w_{l,2} should be named as er or e(l). Here we ignore l for simplicity.

In some implementation, the size of the first type of frequency domain unit depends on at least one of N₁ or N₂. The larger the N₁ or N₂ is, the smaller the size of the first type of frequency domain unit.

In some implementation, the precoding matrix is also based on a third type of vector including N₁N₂ elements. The third vector is based on the first type of vector and the second type of vector. The element with index lN₁+n of the third type of vector has one of the following formats:

$${w}_{{lN}_{1} + n , 3} = {w}_{n , 1} * {w}_{l , 2}$$

$${W}_{{lN}_{1} + n , 3} = {w}_{n , 1} * {w}_{l , 2} + function ( l * n )$$

where function (l*n) is a function of l*n. That is the third type of vector has one of the following formats:

$${W}_{3} = [ \begin{matrix}{W}_{1} \\ {w}_{1 , 2} {W}_{1} \\ ⋮ \\ {w}_{{N}_{2} - 1 , 2} {W}_{1}\end{matrix} ]$$

$${W}_{3} = [ \begin{matrix}{W}_{1} \\ {w}_{1 , 2} {W}_{1} \\ ⋮ \\ {w}_{{N}_{2} - 1 , 2} {W}_{1}\end{matrix} ] + {W}_{12} or$$

$${W}_{3} = [ \begin{matrix}{W}_{1} \\ {w}_{1 , 2} {W}_{1} \\ ⋮ \\ {w}_{{N}_{2} - 1 , 2} {W}_{1}\end{matrix} ] - {W}_{12}$$

The element with index l
N
12
+n of the vector W₁₂ has the following format:

$${w}_{{lN}_{2} + n , 12} = function ( l * n )$$

In some implementation, the precoding matrix is based on a weighted combination of L third type of vectors. L is a positive integer. Different third types of vectors correspond to different values of at least one of b, e, c, d, c₂, d₂. Different third type of vectors correspond to different combinations of b, e. For a same frequency domain location, the L third type of vectors correspond to a same value of the first parameter a.

In some implementation, the precoding matrix for a first type of frequency domain unit k has one of the following matrices:

$${W}_{precoding , k} = [ \begin{matrix}{W}_{3 , k} \\ {fW}_{3 , k}\end{matrix} ]$$

$${W}_{precoding , k} = [ \begin{matrix}{\sum }_{i = 0}^{L - 1} {f}_{1}^{i} {W}_{3 , k}^{i} \\ {\sum }_{i = 0}^{L - 1} {f}_{2}^{i} {W}_{3 , k}^{i}\end{matrix} ]$$

$${W}_{precoding , k} = [ \begin{matrix}{\sum }_{i = 0}^{{L}_{1} - 1} {f}_{1}^{i} {W}_{3 , k}^{i} \\ {\sum }_{i = 0}^{{L}_{2} - 1} {f}_{2}^{i} {W}_{3 , k}^{{L}_{1} + i}\end{matrix} ]$$

$${W}_{precoding , k} = [ \begin{matrix}{W}_{3 , k}^{1} \\ {f}_{2} {W}_{3 , k}^{2}\end{matrix} ]$$

$${W}_{precoding , k} = [ \begin{matrix}{\sum }_{i = 0}^{L - 1} {f}_{1}^{i} {W}_{3 , k}^{i} \\ {\sum }_{i = 0}^{L - 1} {f}_{2}^{i} {W}_{3 , k}^{L + i}\end{matrix} ]$$

$${W}_{precoding , k} = [ \begin{matrix}{\sum }_{i = 0}^{{L}_{1} - 1} {f}_{1}^{i} {W}_{3 , k}^{i} \\ {\sum }_{i = 0}^{{L}_{2} - 1} {f}_{2}^{i} {W}_{3 , k}^{L + i}\end{matrix} ]$$

$${f}_{1}^{i} , {f}_{2}^{i} , {f}_{1} , {f}_{2}$$

are a coefficient including one of amplitude information, phase information, or amplitude information and phase information.

In some implementation, the precoding matrix is based on L third type of vectors and M fourth type of vectors. Each of the fourth type of vector includes N₃ elements. The phase of each element of the fourth type of vectors is based on a product of an index t∈{0, 1, . . . , N₃−1} of a third type of frequency domain unit and an seventh parameter n₃∈{0, 1, . . . , N₃−1} or

$${n}_{3}^{j} ∈ \{ 0 , 1 , … , {N}_{3} - 1 \} ,$$

j∈{0, 1, . . . M−1}. n₃ or

$${n}_{3}^{j}$$

is based on information reported by the UE. M is the number of the fourth type of vector. For example, the precoding matrix for a frequency location with the third type of frequency domain unit index being t and the first type of frequency domain unit index being k has one of the following formats:

$${W}_{precoding , k} = [ \begin{matrix}{\sum }_{i = 0}^{L - 1} ( {W}_{3 , k}^{i} {\sum }_{j = 0}^{M - 1} {f}_{1}^{i , j} {y}_{t}^{j} ) \\ {\sum }_{i = 0}^{L - 1} ( {W}_{3 , k}^{i} {\sum }_{j = 0}^{M - 1} {f}_{1}^{i + L , j} {y}_{t}^{j} )\end{matrix} ]$$

$${W}_{precoding , k} = [ \begin{matrix}{\sum }_{i = 0}^{L - 1} ( {W}_{3 , k}^{i} {\sum }_{j = 0}^{M - 1} {f}_{1}^{i , j} {y}_{t}^{j} ) \\ {\sum }_{i = 0}^{L - 1} ( {W}_{3 , k}^{i + L} {\sum }_{j = 0}^{M - 1} {f}_{1}^{i + L , j} {y}_{t}^{j} )\end{matrix} ]$$

$${W}_{precoding , k} = [ \begin{matrix}{\sum }_{i = 0}^{{L}_{1} - 1} ( {W}_{3 , k}^{i} {\sum }_{j = 0}^{M - 1} {f}_{1}^{i , j} {y}_{t}^{j} ) \\ {\sum }_{i = 0}^{{L}_{2} - 1} ( {W}_{3 , k}^{i + {L}_{1}} {\sum }_{j = 0}^{M - 1} {f}_{1}^{i + {L}_{1} , j} {y}_{t}^{j} )\end{matrix} ]$$

$${W}_{precoding , k} = [ \begin{matrix}{\sum }_{i = 0}^{{L}_{1} - 1} ( {W}_{3 , k}^{i} {\sum }_{j = 0}^{{M}_{1} - 1} {f}_{1}^{i , j} {y}_{t , 1}^{j} ) \\ {\sum }_{i = 0}^{{L}_{2} - 1} ( {W}_{3 , k}^{i + {L}_{1}} {\sum }_{j = 0}^{{M}_{2} - 1} {f}_{1}^{i + L , j} {y}_{t , 2}^{j} )\end{matrix} ]$$

$${y}_{t}^{j} = {e}^{j \frac{2 π {n}_{3}^{j} t}{{N}_{3}}} , {n}_{3}^{j} ∈ \{ 0 , 1 , … {N}_{3} - 1 \} , j = 0 , 1 … M - 1$$

$${y}_{t , i}^{j} = {e}^{j \frac{2 π {n}_{3}^{j , i} t}{{N}_{3}}} , {n}_{3}^{j , i} ∈ \{ 0 , 1 , … {N}_{3} - 1 \} , j = 0 , 1 … M - 1 , i = 1 , 2$$

The

$${n}_{3}^{j} , {n}_{3}^{j , i}$$

is the seventh parameter, which is reported by the UE. In some implementation,

$${n}_{3}^{j}$$

except for

$${n}_{3}^{0}$$

is reported by the UE. The phase of an element of the fourth type of vector is not based on an index of the elements of the first type of vector or the second type of vector.

In some implementation, the first type of vector can be represented by a dot multiplication of two vectors, such as

$${w}_{n , 1 , a + 1} = {w}_{n , 1 , a} {w}_{n , 1 , 1}$$

where

$$a = \frac{k Δ f}{{f}_{0}} ,$$

or a=kr·w_{n,1,x} corresponds to a first type of vector with the first parameter being x. Actually, w_{n,1,a+1}=w_{n,1,a}w_{n,1,1} considering w_{n,1,x}=exp(j2πxb), w_{n,1,1}=exp(j2πb) and w_{n,1,a}=exp(j2πab). The UE reports information about w_{n,1,1} with no information about the first parameter. Then the UE gets the first type of vector based on the w_{n,1,1} and the first parameter. The w_{n,1,1} can be the spatial domain vector.

In some implementation, the UE reports information about the second parameter in PMI (precoding matrix indicator) and does not report the first parameter. If the UE gets CQI (channel quality indicator) based on a precoding matrix, the precoding matrix is based on the first type of vector and the second type of vector as described in this example. For example, the, the UE reports information about w_{n,1,1} which is not related to the first parameter. The precoding matrix is based on w_{n,1,a+1} which depends on w_{n,1,1} and the first parameter. In some implementation, the w_{n,1,1} applies to all of the F first type of frequency domain units. That is the w_{n,1,1} does not depend on the index of the first type of frequency domain unit. Only the w_{n,1,a} depends on the index of the first type of frequency domain unit. That is the UE only reports a wide band w_{n,1,1}. w_{n,1,a+1} only applies to the case where the UE reports wide band w_{n,1,1} and w_{n,1,a+1} does not apply to the case where the UE reports w_{n,1,1} for each sub band.

In another implementation, the w_{n,1,1} should be determined for each frequency domain unit respectively. That is the w_{n,1,1} depends on the index of the frequency domain unit. Then w_{n,1,a+1}=w_{n,1,a}w_{n,1,1,k}. bₖ=−ncₖ+n²dₖ, where cₖ and dₖ is reported for each frequency domain unit whose size is the same or different from the first type of frequency domain unit. For example, the UE reports at least one of cₖ and dₖ for each fifth type of frequency domain unit. w_{n,1,a+1} applies to the case where the UE reports w_{n,1,1} for each sub band.

In some implementation, the UE does not report the information of the precoding matrix and the UE reports CQI. The CQI is based on the precoding matrix determined by above way.

Similarly, the second type of vector can be represented by a dot multiplication of two vectors, such as

$${w}_{n , 2 , a + 1} = {w}_{n , 2 , a} {w}_{n , 2 , 1}$$

where

$$a = \frac{k Δ f}{{f}_{0}} ,$$

or a=kr·w_{n,1,x} corresponds to a second type of vector with the first parameter being x. Actually, w_{n,2,a+1}=w_{n,2,a}w_{n,2,1}=w_{n,2,a+1} considering w_{n,2,x}=exp(j2πxe), w_{n,2,1}=exp(j2πe) and w_{n,2,a}=exp(j2πae). The UE reports information about w_{n,2,1} with no information about the first parameter. Then the UE gets the second type of vector based on the w_{n,2,1} and the first parameter.

In some implementation, the w_{n,2,1} applies all of the F first type of frequency domain units. That is the w_{n,2,1} does not depend on the index of the first type of frequency domain unit. Only the w_{n,2,a} depends on the index of the first type of frequency domain unit. That is the UE only reports a wide band w_{n,2,1}. w_{n,2,a+1} only applies to the case where the UE reports wide band w_{n,2,1} and w_{n,2,a+1} does not apply to the case where the UE reports w_{n,2,1} for each sub band.

In another implementation, the w_{n,2,1} should be determined for each frequency domain unit. That is the w_{n,2,1} depends on the index of the frequency domain unit. Then w_{n,2,a+1}=w_{n,2,a}w_{n,2,1,k}. eₖ=−nc_{2,k}+n²d_{2,k}, where c_{2,k} and d_{2,k} is reported for each fifth type of frequency domain unit whose size is the same or different from the first type of frequency domain unit. For example, the UE reports at least one of c_{2,k} and d_{2,k} for each frequency domain unit. w_{n,2,a+1} applies to the case where the UE reports w_{n,2,1} for each sub band.

In some implementation, the UE reports information related to the third parameter in PMI (precoding matrix indicator) and does not report the first parameter. If the UE gets CQI (channel quality indicator) based on a precoding matrix, the precoding matrix is based on the second type of vector which depends on the w_{n,2,1} and the first parameter. The precoding matrix is based on the first parameter and the third parameter as described in this example. For example, the UE reports information about w_{n,2,1} which is not related to the first parameter. The precoding matrix is based on w_{n,2,a+1} which depends on w_{n,2,1} and the first parameter a.

In some implementation, the relationship between the first type of frequency domain unit and the third type of frequency domain unit should be satisfied with a restriction. For example, the first type of frequency domain unit is a multiple of the third type of frequency domain unit. The third type of frequency domain unit is not related to N₁, N₂. The first type of frequency domain unit is related to N₁, N₂.

In some implementation, at least one of the first type of frequency domain unit and the third type of frequency domain unit is related to a fourth type of frequency domain unit. Each fourth type of frequency domain unit may correspond to a CQI (channel quality indicator).

In above description, for the first type of vector, we view b as the second parameter and say that the second parameter depends on the n and a fourth parameter applying to all elements of the first type of vector. Alternatively, we can say that the second parameter is at least one of n or n². The phase of an element of the first type of vector is based on a product of the first parameter, the second parameter n or n² and a fourth parameter applying to all elements of the first type of vector. The fourth parameter can be

$${m}_{1} {O}_{1} + {q}_{1} , \frac{{m}_{1} , {O}_{1} + {q}_{1}}{{N}_{1} {O}_{1}} ,$$

where the UE reports at least one of m₁, q₁, d for the fourth parameter.

For example

$${w}_{n , 1} = exp ( j 2 π ab ) = exp ( j 2 π a \frac{{m}_{1} {O}_{1} + {q}_{1}}{{N}_{1} {O}_{1}} n )$$

The first parameter is a, the fourth parameter can be

$${m}_{1} {O}_{1} + {q}_{1} or \frac{{m}_{1} {O}_{1} + {q}_{1}}{{N}_{1} {O}_{1}} ,$$

and the second parameter is n.

In some implementation,

$${w}_{n , 1} = exp ( j 2 π ab ) = exp ( j 2 π a \frac{{m}_{1} {O}_{1} + {q}_{1}}{{N}_{1} {O}_{1}} n + j 2 π {adn}^{2} )$$

The two items of b, such as

$$cn = \frac{{m}_{1} {O}_{1} + {q}_{1}}{{N}_{1} {O}_{1}} n$$

and dn², can be separated. Each of the two items is a product of a first parameter, a fourth parameter and a second parameter. The second parameter corresponding to the first item of b is n. The second parameter corresponding to the second item of b is n². For the first of the two items of b, the first parameter is a, the fourth parameter can be

$${m}_{1} {O}_{1} + {q}_{1} or \frac{{m}_{1} {O}_{1} + {q}_{1}}{{N}_{1} {O}_{1}} ,$$

and the second parameter is n. For the second of the two items of b, the fourth parameter can be d, the second parameter can be n² and the first parameter is a.

Similarly, in above description, for the second type of vector, we view e is the third parameter and say that the third parameter depends on the l and a fifth parameter applying for all elements of the second type of vector. Alternatively, we can say that the third parameter is at least one of l or l². The phase of an element of the second type of vector is based on a product of the first parameter, the third parameter l or l². And a fifth parameter applying to all elements of the second type of vector. The fifth parameter can be

$${m}_{2} {O}_{2} + {q}_{2} , \frac{{m}_{2} {O}_{2} + {q}_{2}}{{N}_{2} {O}_{2}} ,$$

or d₂, where the UE reports at least one of m₂, q₂, d₂.

For example

$${w}_{l , 1} = exp ( j 2 π {ab}_{2} ) = exp ( j 2 π a \frac{{m}_{2} {O}_{2} + {q}_{2}}{{N}_{2} {O}_{2}} l )$$

The first parameter is a, the fifth parameter can be

$${m}_{2} {O}_{2} + {q}_{2} or \frac{{m}_{2} {O}_{2} + {q}_{2}}{{N}_{2} {O}_{2}} ,$$

and the third parameter is l.

In some implementation,

$${w}_{l , 1} = exp ( j 2 π ae ) = exp ( j 2 π a \frac{{m}_{2} {O}_{2} + {q}_{2}}{{N}_{2} {O}_{2}} l + j 2 π {ad}_{2} {l}^{2} )$$

The two items of e, such as

$$\frac{{m}_{2} {O}_{2} + {q}_{2}}{{N}_{2} {O}_{2}} l$$

and d₂l², can be separated. Each of the two items is a product of a first parameter, a fifth parameter supplying for all elements of the second type of vector and a third parameter. The third parameter corresponding to the first item of e is l. The third parameter corresponding to the second item of e is l². For the first item of the two items of e, the first parameter is a, the fifth parameter can be

$${m}_{2} {O}_{2} + {q}_{2} , \frac{{m}_{2} {O}_{2} + {q}_{2}}{{N}_{2} {O}_{2}} ,$$

and the third parameter is l. For the second item of the two items of e, the first parameter is a, the fifth parameter can also be d₂ and the third parameter can be l².

In above implementation, the precoding matrix is for one layer. The precoding matrix for each layer can based on the same format of the precoding matrix described in above except that each layer should correspond to respective at least one of the M fourth type of vector, the coefficient

$${f}_{1}^{i} , {f}_{2}^{i} , {f}_{1} , {f}_{1} .$$

Multiple layers can correspond to same set of the third type of vectors.

In some implementation, the UE receives reference signal from base station. The UE determines above precoding matrix based on the received reference signal. The UE reports channel state information based on the above determined precoding matrix. The channel state information includes at least one of information about the precoding matrix and CQI. The information about the precoding matrix includes at least one of the fourth parameter, the fifth parameter and the seventh parameter.

In another implementation, the gNB (one base station) receives reference signal from UE. The gNB determines above precoding matrix based on the received reference signal from UE. The gNB informs the UE information related to the above determined precoding matrix to let the UE to transmit uplink signal using the precoding matrix determined by the information related to the above determined precoding matrix. The gNB can be replaced by other types of base stations.

The information related to the above determined precoding matrix includes at least one of the fourth parameter, the fifth parameter and the seventh parameter.

In a third implementation, the gNB determines a precoding matrix using same way described above. The gNB transmits downlink signal using the determined precoding matrix. The gNB can determine the precoding matrix not according to a reference signal from the UE. The precoding matrix is based on at least one of the first type of vector, the second type of vector, the third type of vectors and the fourth type of vectors. Of course the gNB can determine the precoding matrix according to at least one of a reference signal from the UE and a channel state information reported by the UE.

In some implementation, the above precoding matrix is for one group of CSI-RS ports. The final precoding matrix includes more than one sub precoding matrix. Each of the more than one sub precoding matrix is obtained based on the above away.

In some implementation, each of the more than one sub-precoding matrix corresponds to its respective at least one of first type of vector, second type of vector, third type of vector, and fourth type of vector. For example, the final precoding matrix has the following format.

$${W}_{precoding\_final , k} = [ \begin{matrix}{a}_{0} {W}_{precoding , k , 0} \\ {a}_{1} {W}_{precoding , k , 1} \\ ⋮ \\ {a}_{S - 1} {W}_{precoding , k , S - 1}\end{matrix} ]$$

It includes S sub precoding matrix. Each of the S precoding matrix is obtained using the above method. The S precoding matrix corresponds to its respective third type of vector and its respective aₛ, s∈{0, 1, . . . , S−1}, which is a coefficient. For example, the aₛ, s∈{0, 1, . . . , S−1} is for adjusting the beams of the S sub precoding matrix to add in the same direction. For example, each of the sub precoding matrix has the following format.

$${W}_{precoding\_final , k , s ∈ \{ 0 , 1 , …S - 1 \}} = [ \begin{matrix}{\sum }_{i = 0}^{L - 1} ( {W}_{3 , k , s}^{i} {\sum }_{j = 0}^{M - 1} {f}_{1 , s}^{i , j} {y}_{t , s}^{j} ) \\ {\sum }_{i = 0}^{L - 1} ( {W}_{3 , k , s}^{i} {\sum }_{j = 0}^{M - 1} {f}_{1 , s}^{i + L , j} {y}_{t , s}^{j} )\end{matrix} ]$$

In another implementation, all of the more than one sub-precoding matrix correspond to the same set of at least one of first type of vector, second type of vector, third type of vector, and fourth type of vector. Each of the more than one sub-precoding matrix corresponds to its respective coefficient. For example, the final precoding matrix has the following format.

$${W}_{precoding\_final , k} = [ \begin{matrix}{a}_{0} {W}_{precoding , k} \\ {a}_{1} {W}_{precoding , k} \\ ⋮ \\ {a}_{S - 1} {W}_{precoding , k}\end{matrix} ]$$

The S sub precoding matrix correspond to the same W_{precoding,k} and its respective coefficient aₛ, s∈{0, 1, . . . , S−1}j.

In a third implementation, all of the more than one sub-precoding matrix correspond to the same set of fourth type of vector. Each of the more than one sub-precoding matrix corresponds to its respective coefficient and at least one of first type of vector, second type of vector, and third type of vector. For example, the final precoding matrix has the following format.

$${W}_{precoding\_final , k} = [ \begin{matrix}{a}_{0} {W}_{precoding , k , 0} \\ {a}_{1} {W}_{precoding , k , 1} \\ ⋮ \\ {a}_{S - 1} {W}_{precoding , k , S - 1}\end{matrix} ]$$

Each of the sub precoding matrix has the following format.

$${W}_{precoding , k , sϵ \{ 0 , 1 , … S - 1 \}} = [ \begin{matrix}{\sum }_{i = 0}^{L - 1} ( {W}_{3 , k , s}^{i} {\sum }_{j = 0}^{M - 1} {f}_{1 , s}^{i , j} {y}_{t}^{j} ) \\ {\sum }_{i = 0}^{L - 1} ( {W}_{3 , k , s}^{i} {\sum }_{j = 0}^{M - 1} {f}_{1 , s}^{i + L , j} {y}_{t}^{j} )\end{matrix} ]$$

The S sub precoding matrix correspond to the same fourth type of vector and each of the S sub precoding matrix corresponds to its respective third type of vectors.

### II. Embodiment 2

This embodiment is the same as Embodiment 1 except for the following points.

The first type of vector and the second type of vector correspond to different or same types of frequency domain unit. Then a phase of an element of the first type of vector is based on a product of the first parameter and the second parameter. A phase of an element of the second type of vector is based on a product of a sixth parameter and the third parameter instead of based on a product of the first parameter and the third parameter. The sixth parameter based on an index of a second type of frequency domain unit.

For example, for a same frequency location, the index of the first type of frequency domain unit is k₁ and the size of the first type of frequency domain unit is Δf₁. For the same frequency location, the index of the second type of frequency domain unit is k₂ and the size of the second type of frequency domain unit is Δf₂. Then an element with index n, n∈{0, 1, . . . , N₁−1} of the first type of vector for a first type of frequency domain unit k∈{0, 1, . . . F−1} has one of the following formats:

$${w}_{n , 1} = exp ( j 2 π {a}_{1} b )$$

where a₁ is determined by one of the following formats:

$${a}_{1} = \frac{Δ {f}_{1} {k}_{1}}{{f}_{0}} , {a}_{1} = \frac{Δ {f}_{1} {k}_{1}}{{f}_{0}} + 1 , {a}_{1} = {k}_{1} {r}_{1} , or {a}_{1} = {k}_{1} {r}_{1} + 1 .$$

An element with index l of the N₂ elements is determined by a third parameter depending on l where l∈{0, 1, . . . N₂−1} or l∈{1, . . . N₂−1} and the sixth parameter. For example, the element with index l of N₂ elements has one of the following formats:

$${w}_{l , 2} = exp ( j 2 π e )$$

$${w}_{l , 2} = exp ( j 2 π {a}_{2} e )$$

where a₂ is determined by one of the following formats:

$${a}_{2} = \frac{Δ {f}_{2} {k}_{2}}{{f}_{0}} , {a}_{2} = \frac{Δ {f}_{2} {k}_{2}}{{f}_{0}} + 1 , {a}_{2} = {k}_{2} {r}_{2} , or {a}_{2} = {k}_{2} {r}_{2} + 1 .$$

In above description, the frequency of the carrier corresponding to the first type of vector and the frequency of the carrier corresponding to the second type of vector are same, which is they are f₀. Then if a frequency domain location corresponds to an index of the first type of vector being 0, it also corresponds to an index of the second type of vector being 0.

The number of the first type of frequency domain unit and the number of the second type of frequency domain unit can be different. Then the F in Embodiment 1 can be replaced with F₁ for the first type of vector and the first type of frequency domain unit. The F in Embodiment 1 can be replaced with F₂ for the second type of vector and the second type of frequency domain unit. The x₁, x₂ in Embodiment 1 can be replaced with x_{1,1}, x_{2,1} for the first type of vector and the first type of frequency domain unit. The x₁, x₂ in Embodiment 1 can be replaced with x_{1,2}, x_{2,2} for the second type of vector and the second type of frequency domain unit.

In some implementation, the frequency of the carrier corresponding to the first type of vector and the frequency of the carrier corresponding to the second type of vector can be different, that is they are f_{0,1}, f_{0,2}, respectively. k₁=0 corresponds to f_{0,1}. k₂=0 corresponds to f_{0,2}. The frequency location corresponding to the index of the first type of frequency domain unit being 0 and the frequency location corresponding to the index of the second type of frequency domain unit being 0 can be different. If a frequency domain location corresponds to an index of the first type of vector being 0, its index of the second type of vector can be not 0.

In some implementation, the UE receives signaling. The signaling includes information indicating whether the first type of frequency domain unit with an index being 0 and the second type of frequency domain unit with an index being 0 overlap.

In some implementation, the size of the first type of frequency domain unit Δf₁ is based on N₁. For example, the larger N₁ is, the smaller Δf₁ is.

In some implementation, the size of the first type of frequency domain unit Δf₁ is based on at least one of N₁, a received signaling. For example, the larger N₁ is, the smaller Δf₁ is. The signaling includes information related to Δf₁.

In some implementation, the size of the second type of frequency domain unit Δf₂ is based on N₂. For example, the larger N₂ is, the smaller Δf₂ is.

In some implementation, the size of the second type of frequency domain unit Δf₂ is based on at least one of N₂, a received signaling. For example, the larger N₂ is, the smaller Δf₂ is. The signaling includes information related to Δf₂.

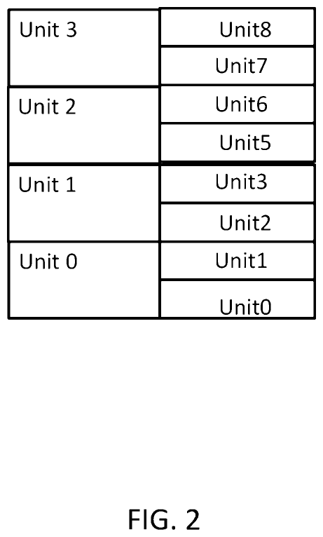

In some implementation, the size of the first type of frequency domain unit Δf₁ and the size of the second type of frequency domain unit Δf₂ should satisfy some restriction. For example, the larger one of Δf₁ and Δf₂ should be a multiple of the smaller one of Δf₁ and Δf₂ as shown in FIG. 2.

In some implementation, at least one of the Δf₁ and Δf₂ is related to the fourth type of frequency domain unit. One fourth type of frequency domain unit corresponds to one CQI (channel quality indicator). For example, at least one of the Δf₁ and Δf₂ is a multiple of the fourth type of frequency domain unit as shown in FIG. 2, where the smaller unit is the fourth type of frequency domain unit, and the larger unit is at least one of the Δf₁ and Δf₂.

In some implementation, at least one of the Δf₁ and Δf₂ is related to the third type of frequency domain unit. For example, at least one of the Δf₁ and Δf₂ is a multiple of the third type of frequency domain unit.

In some implementation, the UE receives signaling which includes information about at least one of Δf₁, Δf₂, f_{0,1}, f_{0,2}, r₁, or r₂.

In some implementation, the relationship between the first type of frequency domain unit and the second type of frequency domain unit is related to the ratio between N₁ and N₂. For example, if N₁ is the larger one between N₁ and N₂, and the ratio

$$\frac{{N}_{1}}{{N}_{2}}$$

between N₁ and N₂ is larger than or equal to a threshold, then the first type of frequency domain unit and the second type of frequency domain unit are different types of frequency domain unit, that is their sizes and frequency domain division are different. If the ratio

$$\frac{{N}_{1}}{{N}_{2}}$$

between N₁ and N₂ is smaller than the threshold, the first type of frequency domain unit and the second type of frequency domain unit are same type of frequency domain unit, that is their size and frequency domain division are the same.

In some implementation, the size of the first type of frequency domain unit depends on the fourth parameter based on information reported by the UE. The larger the fourth parameter is, the smaller the size of the first type of frequency domain unit is. For example, the index of the spatial domain vector includes at least one of m₁O₁+q₁ or m₂O₂+q₂.

In some implementation, the size of the second type of frequency domain unit depends on the fifth parameter based on information reported by the UE. The larger the fifth parameter is, the smaller the size of the fifth type of frequency domain unit is. For example, the index of the spatial domain vector includes at least one of m₁O₁+q₁ or m₂O₂+q₂.

Multiple first type of vectors corresponding to the L third type of vectors corresponds to same value of the first parameter. Multiple second type of vectors corresponding to the L third type of vectors corresponds to same value of the sixth parameter.

W_{precoding,k} should be replaced with W_{precoding,k}_{₁}_{,k}_{₂}. W_{precoding,k,s} should be replaced with W_{precoding,k}_{₁}_{,k}_{₂}_{,s} W_{3,k} should be replaced with W_{3,k}_{₁}_{,k}_{₂}. For example, for a frequency domain location with the first type of frequency domain unit index being k₁, the second type of frequency domain unit index being k₂, the third type of frequency domain vector index being t, the precoding matrix has one of the following formats:

$${W}_{precoding , {k}_{1} , {k}_{2}} = [ \begin{matrix}{\sum }_{i = 0}^{L - 1} ( {W}_{3 , {k}_{1} , {k}_{2}}^{i} {\sum }_{j = 0}^{M - 1} {f}_{1}^{i , j} {y}_{t}^{j} ) \\ {\sum }_{i = 0}^{L - 1} ( {W}_{3 , {k}_{1} , {k}_{2}}^{i} {\sum }_{j = 0}^{M - 1} {f}_{1}^{i + L , j} {y}_{t}^{j} )\end{matrix} ]$$

$${W}_{precoding , {k}_{1} , {k}_{2}} = [ \begin{matrix}{\sum }_{i = 0}^{L - 1} ( {W}_{3 , {k}_{1} , {k}_{2}}^{i} {\sum }_{j = 0}^{M - 1} {f}_{1}^{i , j} {y}_{t}^{j} ) \\ {\sum }_{i = 0}^{L - 1} ( {W}_{3 , {k}_{1} , {k}_{2}}^{i + L} {\sum }_{j = 0}^{M - 1} {f}_{1}^{i + L , j} {y}_{t}^{j} )\end{matrix} ]$$

$${W}_{precoding , {k}_{1} , {k}_{2}} = [ \begin{matrix}{\sum }_{i = 0}^{{L}_{1} - 1} ( {W}_{3 , {k}_{1} , {k}_{2}}^{i} {\sum }_{j = 0}^{M - 1} {f}_{1}^{i , j} {y}_{t}^{j} ) \\ {\sum }_{i = 0}^{{L}_{2} - 1} ( {W}_{3 , {k}_{1} , {k}_{2}}^{i + {L}_{1}} {\sum }_{j = 0}^{M - 1} {f}_{1}^{i + {L}_{1} , j} {y}_{t}^{j} )\end{matrix} ]$$

$${W}_{precoding , {k}_{1} , {k}_{2}} = [ \begin{matrix}{\sum }_{i = 0}^{L - 1} ( {W}_{3 , {k}_{1} , {k}_{2}}^{i} {\sum }_{j = 0}^{M - 1} {f}_{1}^{i , j} {y}_{t}^{j} ) \\ {\sum }_{i = 0}^{L - 1} ( {W}_{3 , {k}_{1} , {k}_{2}}^{i + L} {\sum }_{j = 0}^{M - 1} {f}_{1}^{i + L , j} {y}_{t}^{j} )\end{matrix} ]$$

$${W}_{precoding , {k}_{1} , {k}_{2}} = [ \begin{matrix}{\sum }_{i = 0}^{{L}_{1} - 1} ( {W}_{3 , {k}_{1} , {k}_{2}}^{i} {\sum }_{j = 0}^{{M}_{1} - 1} {f}_{1}^{i , j} {y}_{t , 1}^{j} ) \\ {\sum }_{i = 0}^{{L}_{2} - 1} ( {W}_{3 , {k}_{1} , {k}_{2}}^{i + {L}_{1}} {\sum }_{j = 0}^{{M}_{2} - 1} {f}_{1}^{i + L , j} {y}_{t , 2}^{j} )\end{matrix} ]$$

In some implementation, the UE receives signaling. The signaling includes information indicating whether the first type of frequency domain unit and the second type of frequency domain unit is the same type of vector, and/or indicating whether the first parameter and the sixth parameter are the same parameter.

In some implementation, the UE or the gNB determines the precoding matrix for each of multiple frequency domain units (that is the frequency domain location, it is also can be named as fifth type of frequency domain unit). The number of precoding matrix and/or the number of the multiple fifth type of frequency domain units equals to the largest one of a number of the first type of frequency domain units included in a bandwidth, a number of second type of frequency domain units included in the bandwidth, and a number of third type of frequency domain units included in the bandwidth. The unit of the fifth type of frequency domain unit is one of the first to third type of frequency domain units whose number is the largest one. For example the fifth type of frequency domain unit is one of the first to third type of frequency domain units and the one with the smallest size among the first to third type of frequency domain units. For example, the size of the fifth type of frequency domain unit is smallest among the sizes of the first to the third type of frequency domain units. Then the unit of the fifth type of frequency domain unit is the third type of frequency domain unit. The UE or the gNB determines the precoding matrix for each of the multiple fifth type of frequency domain units. The fifth type of frequency domain unit is based on the smallest size of the three sizes including the first size of the first type of frequency domain unit, the second size of the second type of frequency domain unit and the third size of the third type of frequency domain unit. For example, the fifth type of frequency domain unit is the third type of frequency domain unit.

### III. Embodiment 3

This embodiment is the same as Embodiment 1 except for the following points.

The first parameter is based on a fourth parameter reported by the UE and the second parameter is not based on the fourth parameter.

A phase of an element of the second type of vector is based on a product of a sixth parameter and a third parameter instead of a product of the first parameter and the third parameter.

The sixth parameter is based on the fifth parameter. The third parameter is not based on the fifth parameter reported by the UE.

The phase of an element with index of the first type of vector has one of the following formats:

$${w}_{n , 1} = exp ( j 2 π * \frac{round ( {acN}_{1} {O}_{1} ) n}{{N}_{1} {O}_{1}} ) ) {w}_{n , 1} = exp ( j 2 π * \frac{round ( a ( {m}_{1} {O}_{1} + {q}_{1} ) ) n}{{N}_{1} {O}_{1}} ) ) {w}_{n , 1} = exp ( j 2 π * ( \pm \frac{round ( ac {N}_{1} {O}_{1} ) n}{{N}_{1} {O}_{1}} \pm \frac{round ( ad {D}_{1} ) {n}^{2}}{{D}_{1}} ) ) {w}_{n , 1} = exp ( j 2 π * ( \pm \frac{round ( a ( {m}_{1} {O}_{1} + {q}_{1} ) ) n}{{N}_{1} {O}_{1}} \pm \frac{round ( ad {D}_{1} ) {n}^{2}}{{D}_{1}} ) )$$

where round(x) is an integer nearest to the x. For example, if round(4.6)=5; round(4.4)=4. D₁ is a positive integer. Then at least one of round(acN₁O₁), round(adD₁), round(a(m₁O₁+q₁)) can be viewed as the first parameter. At least one of n, n² can be viewed as the second parameter. Then the first parameter of the first type of vector is based on the fourth parameter. The second parameter is not based on the fourth parameter. Then the first parameter is determined by at least one of the index of the first type of frequency domain unit, the size of the frequency domain unit, the frequency of the carrier, a ratio between the size of the frequency domain unit and the frequency of the carrier, a parameter indicated by a gNB for the CSI reporting, and the fourth parameter.

The phase of an element of the second type of vector is based on a sixth parameter and the third parameter. The sixth parameter is based on an index of the first type of frequency domain unit. The sixth parameter is based on the fifth parameter and the third parameter is not based on the fifth parameter reported by the UE.

The sixth parameter depends on the index of the second type of frequency domain unit and the third parameter depends on the index of the element of the second type vector.

For example, for a first type of frequency domain unit k, the element with index l of the second type of vector has one of the following formats:

$${w}_{l , 2} = exp ( j 2 π * \frac{round ( {ac}_{2} {N}_{2} {O}_{2} ) l}{{N}_{2} {O}_{2}} ) ) {w}_{l , 2} = exp ( j 2 π * \frac{round ( a ( {m}_{2} {O}_{2} + {q}_{2} ) ) l}{{N}_{2} {O}_{2}} ) ) {w}_{l , 2} = exp ( j 2 π * ( \pm \frac{round ( {ac}_{2} {N}_{2} {O}_{2} ) l}{{N}_{2} {O}_{2}} \pm \frac{round ( {ad}_{2} {D}_{2} ) {l}^{2}}{{D}_{2}} ) ) {w}_{l , 2} = exp ( j 2 π * ( \pm \frac{round ( a ( {m}_{2} {O}_{2} + {q}_{2} ) ) l}{{N}_{2} {O}_{2}} \pm \frac{round ( {ad}_{2} {D}_{2} ) {l}^{2}}{{D}_{2}} ) )$$

Here the sixth parameter can be at least one of round(ac₂N₂O₂), round(a(m₂O₂+q₂)), round(ad₂D₂). The third parameter can be at least one of l or l².

The first parameter corresponding to the first type of vector depends on an index of the first type of frequency domain unit and the fourth parameter. The sixth parameter corresponding to the second type of vector depends on an index of the first type of frequency domain unit and a fifth parameter.

In some implementation, at least one of the fourth parameter and the third parameter can be reported by the UE.

In some implementation, at least one of the fourth parameter and the third parameter can be determined by a signaling from gNB and be not reported by the UE.

### IV. Embodiment 4

This embodiment is the same as Embodiment 1 except for the parts described in Embodiment 2 and Embodiment 3.

A phase of an element of the first type of vector is based on a product of the first parameter and the second parameter. A phase of an element of the second type of vector is based on a product of a sixth parameter and the third parameter instead of based on a product of the first parameter and the third parameter.

The first type of vector and the second type of vector correspond to different or same types of frequency domain unit.

The first parameter is based on the fourth parameter and the second parameter is not based on the fourth parameter.

The sixth parameter is based on the fifth parameter and the third parameter is not based on the fifth parameter.

For example, an element with index n, n∈{0, 1, . . . , N₁−1} of the first type of vector for a first type of frequency domain unit k₁∈{0, 1, . . . F−1} has one of the following formats:

$${w}_{n , 1} = exp ( j 2 π * \frac{round ( {a}_{1} c {N}_{1} {O}_{1} ) n}{{N}_{1} {O}_{1}} ) ) {w}_{n , 1} = exp ( j 2 π * \frac{round ( {a}_{1} ( {m}_{1} {O}_{1} + {q}_{1} ) ) n}{{N}_{1} {O}_{1}} ) ) {w}_{n , 1} = exp ( j 2 π * ( \pm \frac{round ( {a}_{1} c {N}_{1} {O}_{1} ) n}{{N}_{1} {O}_{1}} \pm \frac{round ( {a}_{1} d {D}_{1} ) {n}^{2}}{{D}_{1}} ) ) {w}_{n , 1} = exp ( j 2 π * ( \pm \frac{round ( {a}_{1} ( {m}_{1} {O}_{1} + {q}_{1} ) ) n}{{N}_{1} {O}_{1}} \pm \frac{round ( {a}_{1} d {D}_{1} ) {n}^{2}}{{D}_{1}} ) ) {w}_{n , 1} = exp ( j 2 {πa}_{1} b )$$

Where a₁ is determined by one of the following formats:

$${a}_{1} = \frac{Δ {f}_{1} {k}_{1}}{{f}_{0}} , {a}_{1} = \frac{Δ {f}_{1} {k}_{1}}{{f}_{0}} + 1 , {a}_{1} = {k}_{1} {r}_{1} , or {a}_{1} = {k}_{1} {r}_{1} + 1 .$$

For example, the element with index l of N₂ elements for a second type of frequency domain unit has one of the following formats:

$${w}_{l , 2} = exp ( j 2 π * \frac{round ( {a}_{2} {c}_{2} {N}_{2} {O}_{2} ) l}{{N}_{2} {O}_{2}} ) ) {w}_{l , 2} = exp ( j 2 π * \frac{round ( {a}_{2} ( {m}_{2} {O}_{2} + {q}_{2} ) ) l}{{N}_{2} {O}_{2}} ) ) {w}_{l , 2} = exp ( j 2 π * ( \pm \frac{round ( {a}_{2} {c}_{2} {N}_{2} {O}_{2} ) l}{{N}_{2} {O}_{2}} \pm \frac{round ( {a}_{2} {d}_{2} {D}_{2} ) {l}^{2}}{{D}_{2}} ) ) {w}_{l , 2} = exp ( j 2 π * ( \pm \frac{round ( {a}_{2} ( {m}_{2} {O}_{2} + {q}_{2} ) l}{{N}_{2} {O}_{2}} \pm \frac{round ( {a}_{2} {d}_{2} {D}_{2} ) {l}^{2}}{{D}_{2}} ) )$$

Where a₂ is determined by one of the following formats

$${a}_{2} = \frac{Δ {f}_{2} {k}_{2}}{{f}_{0}} , {a}_{2} = \frac{Δ {f}_{2} {k}_{2}}{{f}_{0}} + 1 , {a}_{2} = {k}_{2} {r}_{2} , or {a}_{2} = {k}_{2} {r}_{2} + 1 .$$

If the first type of frequency domain unit and the second type of frequency domain unit are same type of frequency domain unit, then k₁ and k₂ are same. Then a₁=a₂. That is the first parameter and the sixth parameter is determined by a same parameter a for a same frequency location.

If the first type of frequency domain unit and the second type of frequency domain unit are different types of frequency domain unit, then a₁ is not equal to a₂. For example, for a same frequency location,

$${a}_{1} = \frac{Δ {f}_{1} {k}_{1}}{{f}_{0}} and {a}_{2} = \frac{Δ {f}_{2} {k}_{2}}{{f}_{0}} .$$

The sixth parameter is determined by at least one of the index of the second type of frequency domain unit, the size of the second type of frequency domain unit, the frequency of the carrier, a ratio between the size of the second type of frequency domain unit and the frequency of the carrier, a parameter indicated by a gNB for the CSI reporting, and the fifth parameter.

In the above Embodiments 1 to 4, the first type of vector can be named a first vector. The second type of vector can be named a second vector, and so on. That is the first type of vector to the fourth type of vector can be named first vector to fourth vector. That is they may be named same type of vector just with different number of elements or respective number of elements.

Using the methods in this patent document, more accurate precoding matrix is obtained especially in the case where different frequency domain locations correspond to different precoding matrix while the overhead of reporting the precoding matrix by the UE (or informed by the base station) does not increase. The more accurate channel state information can be obtained because of the more accurate precoding matrix. The base station can schedule transmission using parameter that is more matched with the channel. The spectrum efficiency is improved especially for the case with a large number of transmitting antennas and a large number of frequency domain bands.

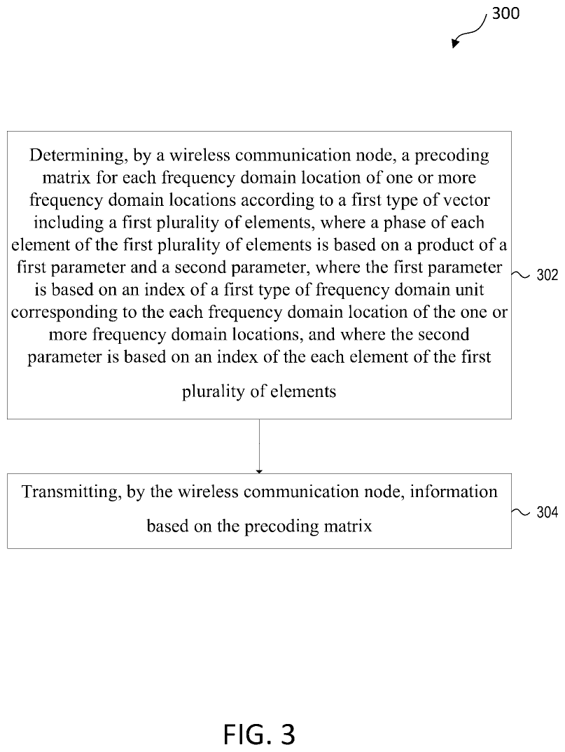

FIG. 3 is an exemplary flowchart for determining a precoding matrix based on a first type of vector and transmitting information. Operation 302 includes determining, by a wireless communication node, a precoding matrix for each frequency domain location of one or more frequency domain locations according to a first type of vector including a first plurality of elements, where a phase of each element of the first plurality of elements is based on a product of a first parameter and a second parameter, where the first parameter is based on an index of a first type of frequency domain unit corresponding to the each frequency domain location of the one or more frequency domain locations, and where the second parameter is based on an index of the each element of the first plurality of elements. Operation 304 includes transmitting, by the wireless communication node, information based on the precoding matrix. In some embodiments, the method can be implemented according to Embodiments 1-4. In some embodiments, performing further steps of the method can be based on a better system performance than a legacy protocol.

In some implementation, Operations 302 and 304 are performed by a base station. For example, the base station determines an uplink precoding matrix based on a reference signal received from UE. The base station informs information related to the precoding matrix to the UE to let the UE transmit uplink signal using the precoding matrix. That is the wireless communication node is a base station.

In another implementation, Operations 302 and 304 are performed by a UE. For example, the UE determines a downlink precoding matrix based on a reference signal received from a base station. The UE transmits CSI to the base station (or to another base station) based on the precoding matrix. That is the wireless communication node is a UE.

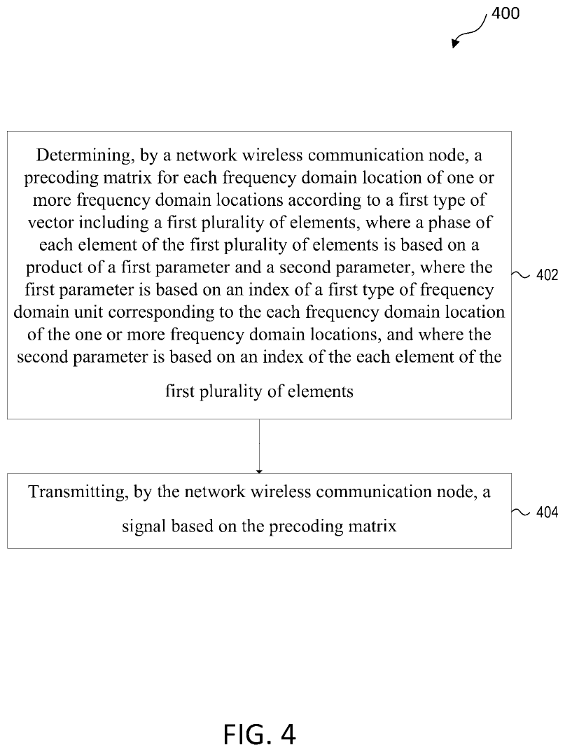

FIG. 4 is an exemplary flowchart for determining a precoding matrix based on a first type of vector and transmitting a signal. Operation 402 includes determining, by a network wireless communication node, a precoding matrix for each frequency domain location of one or more frequency domain locations according to a first type of vector including a first plurality of elements, where a phase of each element of the first plurality of elements is based on a product of a first parameter and a second parameter, where the first parameter is based on an index of a first type of frequency domain unit corresponding to the each frequency domain location of the one or more frequency domain locations, and where the second parameter is based on an index of the each element of the first plurality of elements. Operation 404 includes transmitting, by the network wireless communication node, a signal based on the precoding matrix. In some embodiments, the method can be implemented according to Embodiments 1-4. In some embodiments, performing further steps of the method can be based on a better system performance than a legacy protocol.

In some implementation, Operations 402 and 404 are performed by a base station. For example, the base station determines a downlink precoding matrix based on a reference signal received from UE or based on CSI received from UE. The base station transmits downlink signal based on the determined precoding matrix. The network wireless communication node is a base station.

In another implementation, Operations 402 and 404 are performed by a UE. For example, the UE determines an uplink precoding matrix based on a reference signal received from a base station or information related to the precoding matrix received from gNB. The UE transmits uplink signal using the determined precoding matrix. The network wireless communication node is a UE.

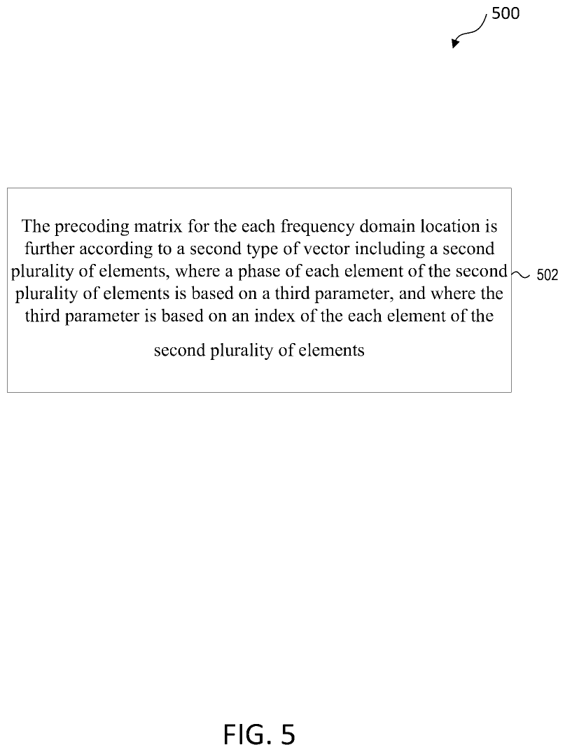

FIG. 5 is an exemplary flowchart for determining a precoding matrix based on a second type of vector. Operation 502 includes that the precoding matrix for the each frequency domain location is further according to a second type of vector including a second plurality of elements, where a phase of each element of the second plurality of elements is based on a third parameter, and where the third parameter is based on an index of the each element of the second plurality of elements. In some embodiments, the method can be implemented according to Embodiments 1-4. In some embodiments, performing further steps of the method can be based on a better system performance than a legacy protocol.

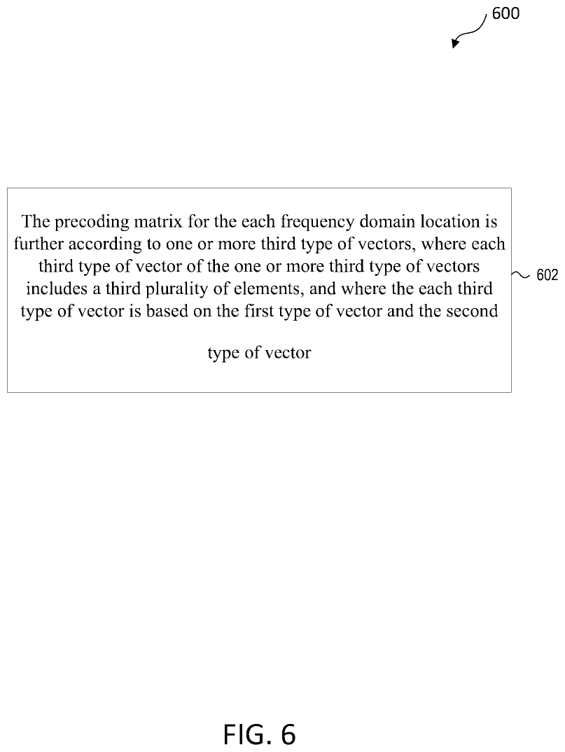

FIG. 6 is an exemplary flowchart for determining a precoding matrix based on a third type of vector. Operation 602 includes that the precoding matrix for the each frequency domain location is further according to one or more third type of vectors, where each third type of vector of the one or more third type of vectors includes a third plurality of elements, and where the each third type of vector is based on the first type of vector and the second type of vector. In some embodiments, each element of the third plurality of elements of the each third type of vector is based on a product of an index of an element of the first plurality of elements of the first type of vector and an index of an element of the second plurality of elements of the second type of vector. In some embodiments, a number of the third plurality of elements is based on a product of a number of the first plurality of elements and a number of the second plurality of elements. In some embodiments, the method can be implemented according to Embodiments 1-4. In some embodiments, performing further steps of the method can be based on a better system performance than a legacy protocol.

In some embodiments, the first parameter is further based on at least one of the following: a size of the first type of frequency domain unit, a frequency of a first carrier, a ratio between the size of the first type of frequency domain unit and the frequency of the first carrier, a parameter in a received signaling, a real number determined by a rule, a fourth parameter applied to all elements of the first plurality of elements, a number of the first plurality of elements, or a first natural number.

In some embodiments, the second parameter is further based on at least one of the following: a number of the first plurality of elements, a first natural number, a power of the index of the each element of the first plurality of elements, or a fourth parameter applied to all elements of the first plurality of elements.

In some embodiments, the first parameter is further based on a first carrier corresponding to a frequency domain location of the one or more frequency domain locations, where the frequency domain location corresponds to a zero-value index of the first type of frequency domain unit. In some embodiments, a size of the first type of frequency domain unit is inversely associated with a number of the first plurality of elements. In some embodiments, a size of the first type of frequency domain unit is determined by a fourth parameter applied to all elements of the first plurality of elements.

In some embodiments, the phase of the each element of the first plurality of elements being based on the product of the first parameter and the second parameter includes the phase of the each element of the first plurality of elements being based on a sum of one or more items, where each item of the one or more items is based on a product of the first parameter, the second parameter, and a fourth parameter applied to all elements of the first plurality of elements.

In some embodiments, the phase of the each element of the first plurality of elements being based on the product of the first parameter and the second parameter includes the phase of the each element of the first plurality of elements being based on a sum of one or more items, where each item of the one or more items is based on a product of the first parameter and the second parameter, and where the first parameter is further based on a fourth parameter applied to all elements of the first plurality of elements.

In some embodiments, all items of the one or more items are based on a same value of the first parameter. In some embodiments, the fourth parameter includes a plurality of parameters, where the each item of the one or more items corresponds to a corresponding parameter of the plurality of parameters. In some embodiments, the second parameter includes a plurality of parameters, where each parameter of the plurality of parameters is based on a respective power of the index of the each element of the first plurality of elements, and where the each item of the one or more items is respectively based on a corresponding parameter of the plurality of parameters.

In some embodiments, different items of the one or more items are based on different powers of the index of the each element of the first plurality of elements. In some embodiments, transmitting the information based on the precoding matrix includes transmitting information related to the fourth parameter. In some embodiments, the index of the first type of frequency domain unit corresponding to the each frequency domain location is determined by a received signaling. In some embodiments, the first type of frequency domain unit includes continuous subcarriers.

In some embodiments, the phase of the each element of the second plurality of elements being based on a third parameter includes the phase of the each element of the second plurality of elements being based on a sum of one or more items, where each item of the one or more items is based on a product of the third parameter and a sixth parameter, and where the sixth parameter is based on an index of a second type of frequency domain unit corresponding to the each frequency domain location.

In some embodiments, all items of the one or more items are based on a same value of the sixth parameter. In some embodiments, the third parameter includes a plurality of parameters, where each parameter of the plurality of parameters is based on a respective power of the index of the each element of the second plurality of elements, and where the each item of the one or more items is based on a corresponding parameter of the plurality of parameters. In some embodiments, different items of the one or more items are based on different powers of the index of the each element of the second plurality of elements.

In some embodiments, the sixth parameter is further based on at least one of the following: a size of the second type of frequency domain unit, a frequency of a second carrier, a ratio between the size of the second type of frequency domain unit and the frequency of the second carrier, a real number determined by a rule, a parameter in a received signaling, or a fifth parameter applied to all elements of the second plurality elements.

In some embodiments, the frequency of the first carrier and the frequency of the second carrier are a same frequency or a frequency range of the first carrier and a frequency range of the second carrier overlap by a portion. In some embodiments, the sixth parameter is further based on a second carrier corresponding to a frequency domain location of the one or more frequency domain locations, where the frequency domain location corresponds to a zero-value index of the second type of frequency domain unit. In some embodiments, the first type of frequency domain unit and the second type of frequency domain unit are a same type of frequency domain unit.

In some embodiments, the first parameter and the sixth parameter have a same value or have a corresponding relationship. In some embodiments, the wireless communication methods further include determining, by the wireless communication node, a relationship between the first type of frequency domain unit and the second type of frequency domain unit or a relationship between the first parameter and the sixth parameter according to at least one of the following: a received signaling or a ratio between a number of the first plurality of elements and a number of the second plurality of elements.

In some embodiments, the third parameter is further based on at least one of the following: a number of the second plurality of elements, a second natural number, a power of the index of the each element of the second plurality of elements, or a fifth parameter applied to all elements of the second plurality of elements. In some embodiments, transmitting the information based on the precoding matrix includes transmitting information related to the fifth parameter.

In some embodiments, the first type of vector corresponds to a horizontal vector, and the second type of vector corresponds to a vertical vector. In some embodiments, the first type of vector corresponds to a vertical vector, and the second type of vector corresponds to a horizontal vector. In some embodiments, a size of the second type of frequency domain unit is determined by at least one of the following: being inversely associated with a number of the second plurality of elements or a fifth parameter applied to all elements of the second plurality elements.

In some embodiments, the index of the second type of frequency domain unit corresponding to the each frequency domain location is determined by a received signaling. In some embodiments, the second type of frequency domain unit includes continuous subcarriers. In some embodiments, a number of the one or more frequency domain locations is the greater of a number of the first type of frequency domain unit included in a bandwidth and a number of the second type of frequency domain unit included in the bandwidth. In some embodiments, a size of the each frequency domain location is the smaller of a size of the first type of frequency domain unit and a size of the second frequency domain unit.

In some embodiments, the one or more third type of vectors correspond to the second type of vector and other multiple second type of vectors, where the second type of vector and the other multiple second type of vectors correspond to a same value of the sixth parameter for a same frequency domain location. In some embodiments, the one or more third type of vectors correspond to the first type of vector and other multiple first type of vectors, where the first type of vector and the other multiple first type of vectors correspond to a same value of the first parameter for a same frequency domain location.

In some embodiments, the precoding matrix for the each frequency domain location is further according to a fourth type of vector including a fourth plurality of elements, where a phase of each element of the fourth plurality of elements is based on a product of an index of a third type of frequency domain unit corresponding to the each frequency domain location and a seventh parameter applied to all elements of the fourth plurality of elements.

In some embodiments, the first type of frequency domain unit and the third type of frequency domain unit satisfy a restriction. In some embodiments, the first type of frequency domain unit is a multiple of the third type of frequency domain unit. In some embodiments, the second type of frequency domain unit and the third type of frequency domain unit satisfy a restriction. In some embodiments, the second type of frequency domain unit is a multiple of the third type of frequency domain unit.

In some embodiments, a number of the one or more frequency domain locations is the greatest of a number of the first type of frequency domain unit included in a bandwidth, a number of the second type of frequency domain unit included in the bandwidth, and a number of the third type of frequency domain unit included in the bandwidth. In some embodiments, a size of the each frequency domain location is the smallest of a size of the first type of frequency domain unit, a size of the second type of frequency domain unit, and a size of the third type of frequency domain unit.

In some embodiments, a size of the third type of frequency domain unit is inversely associated with a number of the third plurality of elements. In some embodiments, the third type of frequency domain unit includes continuous subcarriers. In some embodiments, a fourth type of frequency domain unit and the first type of frequency domain unit satisfy a restriction, where the fourth type of frequency domain unit is associated with a channel quality indicator (CQI). In some embodiments, a fourth type of frequency domain unit and the second type of frequency domain unit satisfy a restriction, where the fourth type of frequency domain unit is associated with a channel quality indicator (CQI).

In some embodiments, a size of the fourth type of frequency domain unit is independent of a number of the third plurality of elements. In some embodiments, the fourth type of frequency domain unit includes continuous subcarriers. In some embodiments, the first type of vector further includes an initial element separate from the first plurality of elements. In some embodiments, transmitting the information based on the precoding matrix for the each frequency domain location includes transmitting at least one of the following: a channel quality indicator (CQI) or information related to the precoding matrix. In some embodiments, the information related to the precoding matrix includes at least one of the following: a fourth parameter, a fifth parameter, a sixth parameter, or a seventh parameter used to determine a fourth type of vector.

In some embodiments, the wireless communication methods further include receiving, by the wireless communication node, a reference signal. In some embodiments, the wireless communication methods further include determining, by the wireless communication node, the precoding matrix based on the reference signal. In some embodiments, the wireless communication methods further include receiving, by the network wireless communication node, information related to a precoding matrix from another wireless communication node. In some embodiments, the wireless communication methods further include determining, by the network wireless communication node, the precoding matrix or the first type of vector based on the information related to the precoding matrix from another wireless communication node.

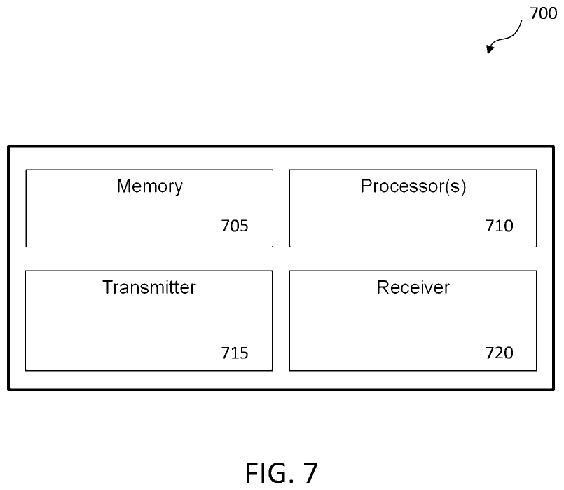

FIG. 7 shows an exemplary block diagram of a hardware platform 700 that may be a part of a network device (e.g., base station) or a communication device (e.g., a user equipment (UE)). The hardware platform 700 includes at least one processor 710 and a memory 705 having instructions stored thereupon. The instructions upon execution by the processor 710 configure the hardware platform 700 to perform the operations described in FIGS. 1 to 6 and in the various embodiments described in this patent document. The transmitter 715 transmits or sends information or data to another device. For example, a network device transmitter can send a message to a user equipment. The receiver 720 receives information or data transmitted or sent by another device. For example, a user equipment can receive a message from a network device. For example, a UE or a network device, as described in the present document, may be implemented using the hardware platform 700.

The implementations as discussed above will apply to a wireless communication.

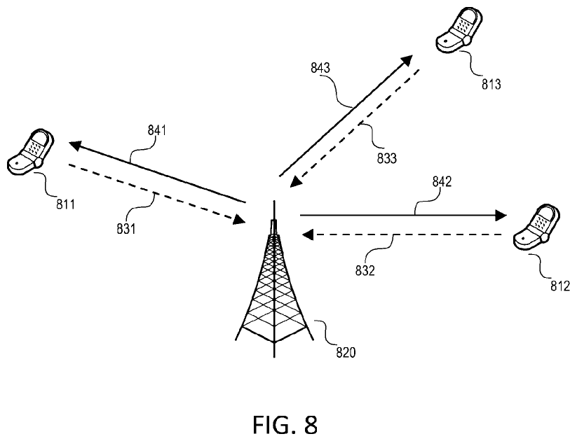

FIG. 8 shows an example of a wireless communication system (e.g., a 5G or NR cellular network) that includes a base station 820 and one or more user equipment (UE) 811, 812 and 813. In some embodiments, the UEs access the BS (e.g., the network) using a communication link to the network (sometimes called uplink direction, as depicted by dashed arrows 831, 832, 833), which then enables subsequent communication (e.g., shown in the direction from the network to the UEs, sometimes called downlink direction, shown by arrows 841, 842, 843) from the BS to the UEs. In some embodiments, the BS send information to the UEs (sometimes called downlink direction, as depicted by arrows 841, 842, 843), which then enables subsequent communication (e.g., shown in the direction from the UEs to the BS, sometimes called uplink direction, shown by dashed arrows 831, 832, 833) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 820 depicted in FIG. 8. The UEs can also communicate with BS for CSI communications.

It will be appreciated by one of skill in the art that the present document discloses methods to determine more accurate precoding matrices especially in the case where different frequency locations correspond to different precoding matrices while the overhead of reporting the precoding matrices by the UE (or informed by the base station) does not increase. More accurate channel state information can be obtained because of the more accurate precoding matrices. Then the spectrum efficiency is improved.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
determining, by a wireless communication node, a precoding matrix for each frequency domain location of one or more frequency domain locations according to a first type of vector comprising a first plurality of elements, wherein a phase of each element of the first plurality of elements is based on a product of a first parameter and a second parameter, wherein the first parameter is based on an index of a first type of frequency domain unit corresponding to the each frequency domain location of the one or more frequency domain locations, and wherein the second parameter is based on an index of the each element of the first plurality of elements; and
transmitting, by the wireless communication node, information based on the precoding matrix.

2. A method of wireless communication, comprising:
determining, by a network wireless communication node, a precoding matrix for each frequency domain location of one or more frequency domain locations according to a first type of vector comprising a first plurality of elements, wherein a phase of each element of the first plurality of elements is based on a product of a first parameter and a second parameter, wherein the first parameter is based on an index of a first type of frequency domain unit corresponding to the each frequency domain location of the one or more frequency domain locations, and wherein the second parameter is based on an index of the each element of the first plurality of elements; and
transmitting, by the network wireless communication node, a signal based on the precoding matrix.

3-6. (canceled)

7. The method of claim 1, wherein;
the first parameter is further based on at least one of the following:
a size of the first type of frequency domain unit, a frequency of a first carrier, a ratio between the size of the first type of frequency domain unit and the frequency of the first carrier, a parameter in a received signaling, a real number determined by a rule, a fourth parameter applied to all elements of the first plurality of elements, a number of the first plurality of elements, or a first natural number.

8. The method of claim 1, wherein the second parameter is further based on at least one of the following:
a number of the first plurality of elements, a first natural number, a power of the index of the each element of the first plurality of elements, or a fourth parameter applied to all elements of the first plurality of elements.

9. The method of claim 1, wherein the first parameter is further based on a first carrier corresponding to a frequency domain location of the one or more frequency domain locations, and wherein the frequency domain location corresponds to a zero-value index of the first type of frequency domain unit.

10. The method of claim 1, wherein a size of the first type of frequency domain unit is inversely associated with a number of the first plurality of elements.

11. The method of claim 1, wherein
a size of the first type of frequency domain unit is determined by a fourth parameter applied to all elements of the first plurality of elements.

12. The method of claim 1, wherein:
the phase of the each element of the first plurality of elements being based on the product of the first parameter and the second parameter comprises the phase of the each element of the first plurality of elements being based on a sum of one or more items, and wherein each item of the one or more items is based on a product of the first parameter, the second parameter, and a fourth parameter applied to all elements of the first plurality of elements.

13. (canceled)

14. The method of claim 12, wherein all items of the one or more items are based on a same value of the first parameter.

15. The method of claim 12, wherein the fourth parameter comprises a plurality of parameters, and wherein the each item of the one or more items corresponds to a corresponding parameter of the plurality of parameters.

16. The method of claim 12, wherein the second parameter comprises a plurality of parameters, wherein each parameter of the plurality of parameters is based on a respective power of the index of the each element of the first plurality of elements, and wherein the each item of the one or more items is respectively based on a corresponding parameter of the plurality of parameters.

17. (canceled)

18. The method of claim 7, wherein transmitting the information based on the precoding matrix comprises transmitting information related to the fourth parameter.

19. (canceled)

20. The method of claim 1, wherein the first type of frequency domain unit comprises continuous subcarriers.

21-41. (canceled)

42. The method of claim 1, wherein the precoding matrix for the each frequency domain location is further according to a fourth type of vector comprising a fourth plurality of elements, and wherein a phase of each element of the fourth plurality of elements is based on a product of an index of a third type of frequency domain unit corresponding to the each frequency domain location and a seventh parameter applied to all elements of the fourth plurality of elements.

43. (canceled)

44. The method of claim 42, wherein the first type of frequency domain unit is a multiple of the third type of frequency domain unit.

45-50. (canceled)

51. The method of claim 1, wherein a fourth type of frequency domain unit and the first type of frequency domain unit satisfy a restriction, and wherein the fourth type of frequency domain unit is associated with a channel quality indicator (CQI).

52-58. (canceled)

59. The method of claim 2, further comprising:
receiving, by the network wireless communication node, information related to a precoding matrix from another wireless communication node; and
determining, by the network wireless communication node, the precoding matrix or the first type of vector based on the information related to the precoding matrix from another wireless communication node.

60. An apparatus for wireless communication, comprising a processor, wherein the processor is configured to implement a method recited in claim 1.

61. (canceled)

62. The method of claim 2, wherein:
the first parameter is further based on at least one of the following:
a size of the first type of frequency domain unit, a frequency of a first carrier, a ratio between the size of the first type of frequency domain unit and the frequency of the first carrier, a parameter in a received signaling, a real number determined by a rule, a fourth parameter applied to all elements of the first plurality of elements, a number of the first plurality of elements, or a first natural number; or
the first parameter is further based on a first carrier corresponding to a frequency domain location of the one or more frequency domain locations, and wherein the frequency domain location corresponds to a zero-value index of the first type of frequency domain unit.

63. The method of claim 2, wherein the second parameter is further based on at least one of the following:
a number of the first plurality of elements, a first natural number, a power of the index of the each element of the first plurality of elements, or a fourth parameter applied to all elements of the first plurality of elements.
